(19) United States
(12) Patent Application Publication
(10) Pub. No.: US 2003/0023598 A1
(43) Pub. Date: Jan. 30, 2003

(54) Dynamic composite advertisements for distribution via computer networks

(75) Inventors: Janani Janakiraman, Austin, TX (US); Rabindranath Dutta, Austin, TX (US); Dwip N. Banerjee, Austin, TX (US)

Correspondence Address: Robert H. Frantz, P.O. Box 23324, Oklahoma City, OK, 73123-2334, US

(73) Assignee: International Business Machines Corporation, Armonk, NY (US)

(21) Appl. No.: 09/915,838

(22) Filed: Jul. 26, 2001

(51) Int. Cl. G06F 17/30; G06F 17/60; G06F 7/00

(52) U.S. Cl. 707/10; 705/14

(57) ABSTRACT

According to demographic or other web site visitor characteristics, selection is made of two or more graphic images and/or web objects to be dynamically combined into a single composite advertisement to render a highly targeted advertisement message. This allows a smaller database of advertisement data objects to be maintained, while producing advertisements which more closely match a consumer's characteristics. Further, effectiveness tracking of each combination allows for the system to self-optimize for the creation and delivery of the most effective advertisements.

### BACKGROUND OF THE INVENTION

1. Field of the Invention

This invention relates to the art of dynamic generation of advertisements for a computer network, such as the Internet, for delivery to advertising to consumers, such as users of Internet web browsers. This invention also relates to the arts of customized and targeted advertising over electronic media.

2. Description of the Related Art

The proliferation of e-commerce on the World Wide Web (WWW) has offered immense potential for revenue generation through advertisements. The web offers unprecedented opportunities for personalized advertisements, and there has been stunning innovations in customized advertising over the last few years.

Turning to FIG. 1, the well-known arrangement of client browser computers (1), web servers (5) and Advertising servers (“Ad Server”) (6) are shown. The client browser computer (1) typically is equipped with software such as a web browser and a communications protocol stack such that it may connect to and communicate via the World Wide Web (3). Client browser computers include conventional personal computers as well as web-enabled wireless telephones, personal digital assistants (PDAs), and Internet appliances such as WebTV [TM] and MailStation [TM].

A web server (5) is usually provided with one or more data files of web page content such that they may be delivered to a client browser computer upon request, such as by hypertext transfer protocol (HTTP). The web server is also communicably connected to the World Wide Web (3) or another suitable computer network. IBM's WebSphere [TM] enterprise server software combined with a suitable networking computing platform, such as a personal computer running IBM's AIX [TM] operating system, is an example of one such web server (5).

Some web pages include advertisements, such as banner ads, which include information for a user to view regarding products or services being promoted by the sponsors of the web server or web page being viewed. Many online businesses including search engines, travel services, news services, etc., have become dependent on generation of revenue through advertising as many of these companies offer their “services” at not cost to the web “visitor”.

These “ads” are typically delivered by an Ad Server (6), which is also connected to the Internet or World Wide Web (3). In FIG. 2, the well-known process of merging ads (23) and web page contents (24) to be displayed on a portion of a client display (20) in a web browser frame (21) is shown.

The web browser frame (21) typically includes a set of navigation controls (22) such as Back and Forward buttons, as well as a Universal Resource Locator (URL) address selector. Displayed in the display frame of the web browser is the selected (“pointed to”) web page content (24), which is retrieved (26) from the web server (5) using a protocol such as HTTP.

An ad (23) located on the page is delivered typically from a separate server such as and Ad Server (6), through a common web page inclusion method in the code for the page content, such as a direct hyperlink (25) to the advertising object on the ad server (5), or through an Hyper Text Markup Language (HTML) “include” statement. These ad objects are typically graphic image files, such as Graphic Interchange Format (GIF) or Joint Photographic Experts Group (JPEG), additional web page code such as HTML, or even audio or video clips such as “WAV” or “AVI” files.

The web browser software first retrieves a base web page from the web server, and then retrieves all the data items or objects which are referred to in the web page code, such as a graphic image or additional sections of html. Thus, what is displayed to the user after retrieving all of the referred to objects, is a combination of all the items included in the web page source code.

Many well-known methods such as using user IDs, cookies, or URL re-writing, are used to identify the user (or at least the browsing session), and to select an ad (23) to be displayed on the web page.

For example, a particular user may be known to be a senior citizen, and as such ads may be selected which are targeted towards the demographic population segment of older citizens. This identification could come from the user's profile associated with his or her user or login name, through data stored in a cookie on the user's computer, or even through information received from the previous web site visited or a referring web site such as a search engine (“clickthrough” information).

Another user may be identified as belonging to the college student population segment, and as such, an ad appropriate and targeted towards college students may be delivered to this visitor, even though the basic web page content (24) delivered is the same as the senior citizen received.

However, each one of these targeted ads, even though they are selected for user's characteristics, must be individually produced in order to appeal to the particular targeted demographic group. For example, two separate ads must be produced, one for a senior citizen and one for a college student, in the above example. In the first ad, a message and human model or spokesperson who is also a senior citizen may be featured. In the second ad, a message and human model may be featured who is of the age range considered to be representative of a typical college student. It is well known in the advertising industry that consumers respond to advertisements which feature human models and spokespersons who are similar to themselves, in age, gender, ethnic background, economic strata, etc.

When one considers how many potential combinations of demographics including race and ethnic background, income level, nationality, age, gender, religion, and even the time of day that the browsing is being conducted, one can imagine that hundreds to thousands of targeted ads may have to be produced in order to effectively deliver an advertisement for a particular demographic section of the population.

While this is technically possible to be done, it can be very expensive and time consuming to produce all of these varieties of ads for each and every product and service which may be advertised or promoted through a web site. Generally, this expense is avoided, and a few ads are produced in the hope of each ad addressing a larger population segment, or combination of population segments. This results in lower advertising expense at the cost of effectiveness of the ads themselves.

Therefore, there is a need in the art for a system and method which can generate dynamic advertisement content based on combinations of demographic factors for a particular visitor or advertising consumer. Further, there is a need in the art for this system and method to be compatible with common day technologies and protocols employed on a web site servers and web browser software. Additionally, there is a need in the art for this system to provide a means to optimize the effectiveness of dynamically produced ads to achieve maximum usefulness of the system.

### BRIEF DESCRIPTION OF THE DRAWINGS

The following detailed description, when taken in conjunction with the figures presented herein, provides a complete disclosure of the invention.

FIG. 1 illustrates the well-known arrangement of ad servers, web servers, and client browser computers interconnected by the World Wide Web or similar computer network.

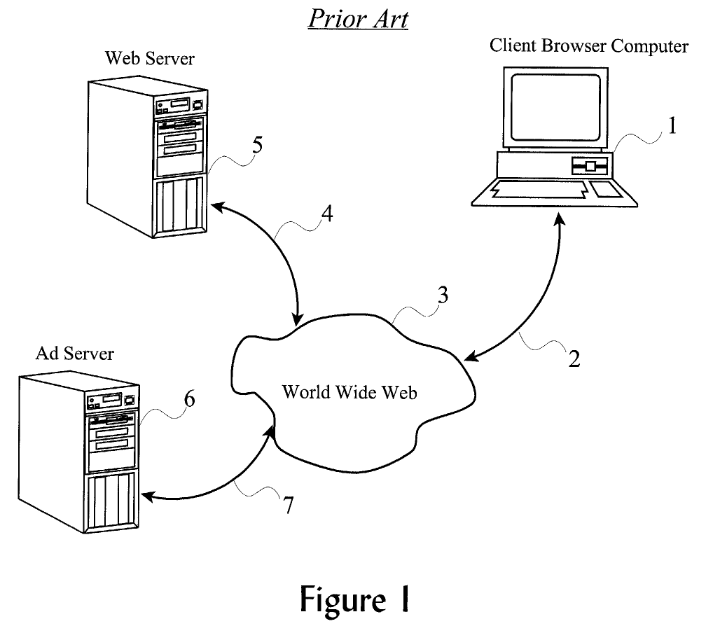

FIG. 2 illustrates the well-known process of delivering electronic advertisements and web page contents to a client web browser computer.

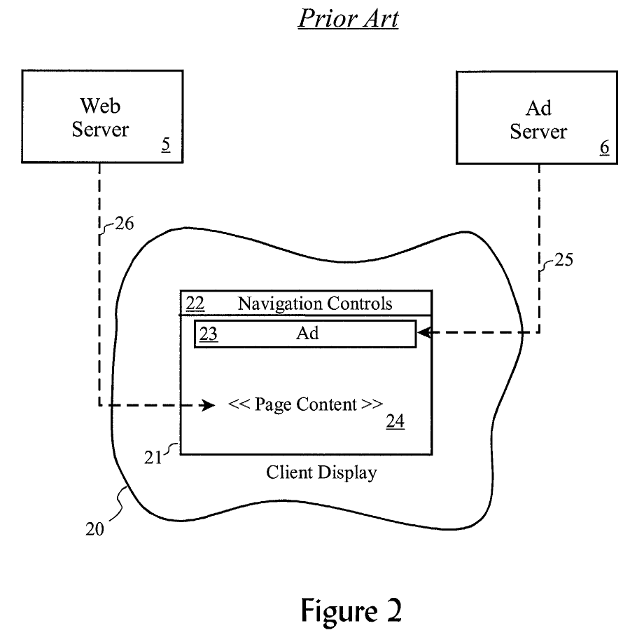

FIG. 3 graphically discloses the logical process and interrelationship of the various components necessary for creating and delivering dynamic composite advertisements.

FIGS. 4a and 4b illustrate two individual graphic images which may be selected in a particular user's case to be combined to create a dynamic advertisement.

FIG. 5 illustrates the composite advertisement as viewed by a user on a web browser display.

### SUMMARY OF THE INVENTION

The present invention offers two improvements in the art of delivering electronic advertisements for consumption, e.g. viewing and/or hearing, by a user. In a first level of customization, selection is made of two or more graphic images and/or web objects to be dynamically combined into a single composite advertisement, the selection being based upon user identification characteristics such as demographics.

These dynamically generated composite advertisements provide the ability to maintain a smaller database of advertisement data objects which can be recombined in realtime in a plurality of combinations to achieve a presentation which targets a particular consumer group or demographic section of the population.

In the second aspect of the invention, the effectiveness of the particular combinations of data objects in the composite advertisements is measured using well-known techniques, the results of which are used to modify the feature presentations of the dynamic ads such that more effective ads are selected more often, and less effective advertisement combinations are selected less often.

In a third aspect of the invention, a pseudo-random presentation of a dynamically generated advertisement is made in order to refresh the effectiveness data, so that the data used to select and prepare a dynamic composite ad for a particular user or demographic segment does not become “stale” or dated.

### DETAILED DESCRIPTION OF THE INVENTION

According to the preferred embodiment, the present invention is realized as software processes executed on or by advertisement servers such as an IBM WebSphere [TM] e-commerce platform, running on a common web server computer such as a personal computer or and IBM AS/400 computer system.

The IBM WebSphere [TM] product is available for many operating systems such as Linux, IBM's AIX [TM], or Microsoft Windows NT. However, it will be recognized by those skilled in the art that alternate e-commerce software suites and computer platforms may be adopted without departing from the spirit and scope of the present invention.

As such, the remainder of this disclosure focuses on the logical processes to be implemented in software on such a web server, using a suitable programming methodology and language. According to the preferred embodiment, the logical processes are implemented as Java servlets and/or Enterprise Java Beans (EJB), but, again, it will be recognized by those skilled in the art that it is possible to implement the present invention using alternate languages and programming methodologies.

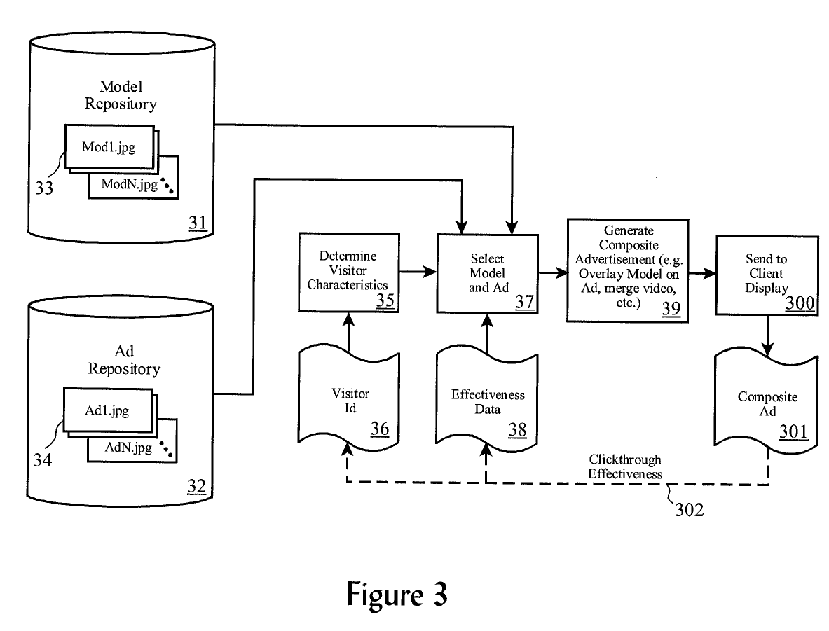

Turning to FIG. 3, the invention's logical process and interrelationships are shown. According to the preferred embodiment, all of the shown components and processes are executed on an ad server. However, some or all of the components and processes may be executed on other servers or even on the client browser computer itself.

There are at least two data repositories in the system: a model repository (31) and an ad repository (32). Within the model repository (31) are disposed a plurality of model data objects (33), such as graphic images, video clips, and sound clips. Common web object data formats may be used for any of these, such as JPEG, GIF, AVI, and WAV files. According to the preferred embodiment, these models are preferably human models, but alternatively could by other models such as cartoon characters. Each graphic image in the model repository (31) is indexed for the demographic segment to which it may appeal the most. For example, a model repository may have N images, each image containing photographs of models with different demographic characteristics, such as different ethnic backgrounds, different ages, and even different group compositions such as families, singles, and couples.

The ad repository (32) similarly contains a plurality of advertisement data objects (34). Each of these advertisement data objects (34) may also be a graphic image file, a section of web page code such as HTML, or video and audio clips. Again, similar to the model repository, the common data object formats such as JPEG, GIF, WAV, and AVI may be employed as data objects. Each data object within the ad repository represents a different advertisement “background” or message, in general. For example, one ad image file may represent vacation advertisements to a destination such as Florida. Another data object in the ad repository may represent opportunities to purchase books regarding investment subjects or retirement planning.

Having these two or more repositories (or more) allows a dynamically generated advertisement to be composed of a plurality of components, each selected from the various repositories based upon relevant visitor characteristics. For example, if a user is known to be interested in investments and to be a senior citizen, an image of a celebrity senior citizen may be selected from the model repository, and an ad regarding investment opportunities or investment services may be selected from the ad repository. These two images—a senior celebrity with a investment services ad—are then combined to create a highly targeted composite advertisement.

As such, the process shown in FIG. 3 first determines the visitor's characteristics (35) by receiving a set of visitor identification (36) data items. Many well-known methods for identifying these visitors and tracking browsing sessions are available in the art, including URL rewriting, depositing and retrieving of cookies, or receiving a user profile which was created by the user upon registration for his or her user ID.

After the visitor's characteristics have been determined (35), two or more data objects are selected from the repositories which match the interests and demographics of the visitor, and preferably which match the user's preferences such as to receive or not to receive video clips.

Also according to the preferred embodiment, effectiveness data (38) of each combination may be consulted during the selection process (37) so that a historically more effective combination may be selected over a historically less effective combination.

In the next step of the process, the image or data object from the model repository is overlaid or combined with the ad repository data object to create a composite advertisement data object (39). In the case of graphic images, the model image which was selected from the model repository may simply be overlaid on top of the background image from the ad repository, with basic image processing such as edge smoothing applied. If one of the repositories contains audio or video clips, these may also be included in an appropriate manner with the ad data object in the ad repository, using available realtime multimedia and vector animation technologies such as Macromedia's Flash [TM] or Shockwave.

In the next step of the process, the visitor's browser is sent the composite advertisement (300), so that it may be viewed and/or heard by the web site visitor.

According to the preferred embodiment, all of the steps and components disclosed in FIG. 3 are executed by one or more networked ad servers. However, some or all of the steps and components may be executed by the client browser computer. For example, the repositories could be stored “locally” in memory of the client computer, with the selection, merge, and display process being performed by client-side software such as a Java applet or browser plug-in. Other combinations of coordinated functions on both the server and the client browser computer can be adopted, as well, depending on the communications bandwidth available between the ad server and the client browser computer, processing and data storage capacities of the browser computer, and advertising technologies employed.

In another aspect of the invention, the effectiveness of the particular combination is measured and recorded in the effectiveness data (38) using well-known effectiveness measuring techniques (302), such as “clickthrough” counting. A “clickthrough” in Internet advertising parlance refers to the event when a user clicks on a displayed advertisement and successfully receives the linked page or web content, which is usually a larger or full advertisement. Clickthrough tracking, which is well-known in the art, refers to the techniques for counting or measuring clickthroughs, which can be an indication of the effectiveness of a particular advertisement or web page.

Alternate commonly used anonymous session tracking techniques may be employed to update the effectiveness data (38), such as tracking the number of times a user revisits a particular web site or advertisement, tracking the amount of time between clicks using client-side processes, or depositing and retrieving time-stamped cookies on the client computer.

TABLE 1
Example Effectiveness Data

| User | Demographics | Ad# | Model# | Clickthroughs | Hits |
|---|---|---|---|---|---|
| Bob | student | 23 | 15 | 4 | 1 |
| Claire | at-home mom | 23 | 12 | 7 | 4 |
| David | senior citizen | 23 | 19 | 5 | 2 |

This effectiveness data may be indexed to the visitor identification (36), the visitor's demographic characteristics, and/or the particular models and advertising objects. During an initial testing period, the data may be collected using a set of initial models and advertising messages, which will establish a baseline of effectiveness data. The effectiveness data is then stored in a effectiveness data repository (38). According to the preferred embodiment, this information is continuously or periodically updated over time as various combinations of advertisements are presented to each visitor and to visitors from each demographic group.

During future dynamic generation of composite advertisements, the effectiveness data and visitor ID information may be used as one set of parameters in the selection of appropriate data objections to be combined for the composite advertisement. This provides somewhat of a “learning” or adaptive characteristic and self-optimization feature to the preferred embodiment of the invention, which allows it to optimize its delivery of composite advertisements for the most effective components for each visitor or each visitor demographic group.

Further, according to the preferred embodiment, the effectiveness data is “refreshed” periodically by pseudo-randomly delivering new combinations of composite advertisements which are not indicated by the historical effectiveness trend as being the most effective. This keeps the effectiveness data from becoming stale over time, and allows for new combinations to be introduced and tested on a pseudo-random basis.

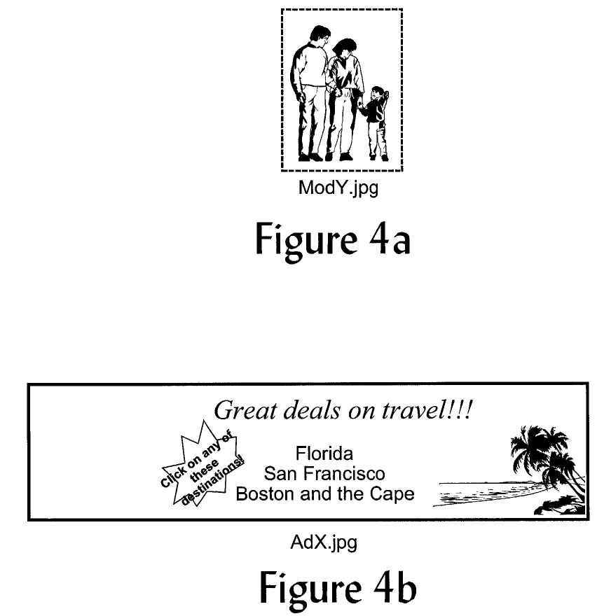

Turning to FIGS. 4a and 4b, examples of two data items selected from two repositories for a particular visitor characteristics are shown. FIG. 4a shows a model graphic image of a family, and a young family at that. This image file may be indexed in multiple ways in the model repository (31) as “family” and “family with young children”.

FIG. 4(b) shows a potential advertisement message or background for vacation or travel. This image file may be indexed in multiple ways in the ad repository (32) as “travel” and “vacation”.

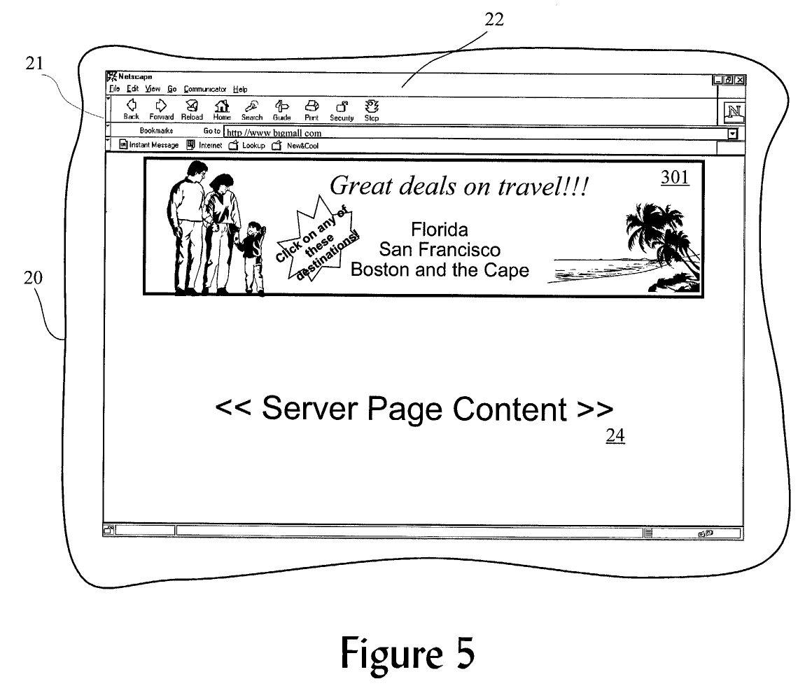

Based upon a particular visitor's characteristics, such as the known fact that the visitor is interested in travel and is a family member (perhaps the user “clickthrough” from a web site concerning family vacation planning), the two graphic images shown in FIGS. 4a and FIG. 4b may be combined on a dynamic basis to create the composite banner ad (301) shown in FIG. 5 for display a web browser viewing frame.

For alternate visitors with other characteristics, such as senior citizens, couples without children, singles, or extreme sports enthusiasts, for example, other graphic images than that shown in FIG. 4a may be combined with the same advertisement image shown in FIG. 4b to promote travel and vacation services to those demographic segments of the population.

While particular details of a preferred embodiment have been disclosed herein, it will be recognized by those skilled in the art that many variations to the preferred embodiment may be made without departing from the spirit and scope of the invention, including but not limited to adoption of alternate programming languages and methodologies, multimedia technologies, and networking protocols. Therefore, the scope of the present invention should be determined by the following claims.

What is claimed is:

1. A method for dynamically generating targeted electronic advertisements comprising the steps of:
providing two or more data object repositories, said data object repositories containing a plurality of data objects indexed to target audience characteristics;
selecting two or more data objects from said data object repositories based upon a given set of instant user characteristics;
producing a composite advertisement object by combining said selected data objects to render a single advertisement data object; and
providing for consumption said composite advertisement object to a to said instant user.

2. The method as set forth in claim 1 wherein said step of providing two or more data object repositories comprises providing a human model repository.

3. The method as set forth in claim 2 wherein said step of providing a human model repository is selected from the group consisting of providing a still graphic image repository, providing a video clip repository, and providing an audio clip repository.

4. The method as set forth in claim 1 wherein said step of providing two or more data object repositories comprises providing an advertising message repository.

5. The method as set forth in claim 4 wherein said step of providing an advertising message repository is selected from the group consisting of providing a still graphic image repository, providing a video clip repository, providing a web page repository, and providing an audio clip repository.

6. The method as set forth in claim 1 wherein said step of selecting two or more data objects from said data object repositories based upon a given set of instant user characteristics comprises selecting data objects based upon instant user demographic factors.

7. The method as set forth in claim 1 wherein said step of selecting two or more data objects from said data object repositories based upon a given set of instant user characteristics comprises selecting data objects based upon historical advertising effectiveness trend data.

8. The method as set forth in claim 1 wherein said step of producing a composite advertisement object is selected from the group consisting of overlaying one still graphic image data object over another, merging a video clip with an audio clip, and merging a plurality of video clips.

9. The method as set forth in claim 1 wherein said step of providing for consumption a composite advertisement object to an instant user is selected from the group consisting of transmitting said composite advertisement object over a computer network, displaying said composite advertisement, and playing said composite advertisement.

10. The method as set forth in claim 7 further comprising a step of updating said historical advertising effectiveness trend data according to subsequent instant user selection of options related to said composite advertisement object.

11. A computer readable medium encoded with software for dynamically generating targeted electronic advertisements comprising, said software when executed causing a computer to perform the steps of:
provide two or more data object repositories, said data object repositories containing a plurality of data objects indexed to target audience characteristics;
select two or more data objects from said data object repositories based upon a given set of instant user characteristics;
produce a composite advertisement object by combining said selected data objects to render a single advertisement data object; and
provide for consumption said composite advertisement object to a to said instant user.

12. The computer readable medium as set forth in claim 11 wherein said software for providing two or more data object repositories comprises software for providing a human model repository.

13. The computer readable medium as set forth in claim 12 wherein said software for providing a human model repository is adapted to provide repository objects selected from the group consisting of a graphic image, a video clip, and an audio clip.

14. The computer readable medium as set forth in claim 11 wherein said software for providing two or more data object repositories comprises providing an advertising message repository.

15. The computer readable medium as set forth in claim 14 wherein said software for providing an advertising message repository is adapted to provide repository objects selected from the group consisting of a still graphic image, a video clip, a web page, and an audio clip.

16. The computer readable medium as set forth in claim 11 wherein said software for selecting two or more data objects comprises software for selecting data objects based upon instant user demographic factors.

17. The computer readable medium as set forth in claim 11 wherein said software for selecting two or more data objects comprises software for selecting data objects based upon historical advertising effectiveness trend data.

18. The computer readable medium as set forth in claim 11 wherein said software for producing a composite advertisement object is adapted to perform a composite advertisement selected from the group consisting of a still graphic image overlaid on another still graphic image, a video clip merged with an audio clip, and a plurality of video clips merged together.

19. The computer readable medium as set forth in claim 11 wherein said software for providing for consumption a composite advertisement object to an instant user is adapted to use a method selected from the group consisting of transmitting said composite advertisement object over a computer network, displaying said composite advertisement, and playing said composite advertisement.

20. The computer readable medium as set forth in claim 17 further comprising software for updating said historical advertising effectiveness trend data according to subsequent instant user selection of options related to said composite advertisement object.

21. A system for dynamically generating targeted electronic advertisements comprising:
two or more data object repositories, said data object repositories containing a plurality of data objects indexed to target audience characteristics;
a data object selector for selecting two or more data objects from said data object repositories based upon a given set of instant user characteristics;
a composite advertisement object renderer for combining said selected data objects to render a single advertisement data object; and
a rendered composite advertisement object provided for consumption to a to said instant user.

22. The system as set forth in claim 21 wherein said data object repositories comprise a human model repository.

23. The system as set forth in claim 22 wherein said human model repository includes a data object selected from the group consisting of still graphic images, video clips, and audio clips.

24. The system as set forth in claim 21 wherein said data object repositories comprise an advertising message repository.

25. The system as set forth in claim 24 wherein said advertising message repository includes a data object selected from the group consisting of still graphic images, video clips, web pages, and audio clips.

26. The system as set forth in claim 21 wherein said data objects selector is adapted to select data objects from said data object repositories based upon instant user demographic factors.

27. The system as set forth in claim 21 wherein said data objects selector is adapted to select data objects based upon historical advertising effectiveness trend data.

28. The system as set forth in claim 21 wherein said composite advertisement object renderer is adapted to produce a composite advertisement object selected from the group consisting of two overlaid still graphic images, a merged video clip and audio clip, and a merged plurality of video clips.

29. The system as set forth in claim 21 further comprising a historical data updater for updating said historical advertising effectiveness trend data according to subsequent instant user selection of options related to said composite advertisement object.
